(19) United States
(12) Patent Application Publication
(10) Pub. No.: US 2026/0273368 A1
(43) Pub. Date: Sep. 17, 2026

(54) AN ELECTRONIC PUNCHING BAG APPARATUS

(71) Applicant: BHT, UNIPESSOAL. Lda, Leiria (PT)

(72) Inventors: Mauro ANGELO JORGE FROTA, Leiria (PT); Pedro Jorge RATAO BATISTA BARATA, Leiria (PT)

(21) Appl. No.: 19/472,670

(22) PCT Filed: Jan. 5, 2024
(86) PCT No.: PCT/IB2024/050101

§ 371 Date: Oct. 5, 2025

(30) Foreign Application Priority Data
Apr. 6, 2023 (PT) 118591
Jan. 4, 2024 (PT) 119193

(51) Int. Cl. A63B 69/32; A63B 24/00; G06N 20/00

(52) U.S. Cl. CPC A63B 69/32; A63B 24/0062; G06N 20/00; A63B 2220/05; A63B 2220/40; A63B 2220/53; A63B 2220/806; A63B 2220/833

(57) ABSTRACT

It is disclosed an electronic punching bag apparatus comprising a punching bag (1), an anchoring unit (2) adapted to fix the apparatus to at least one surface and an impact measurement unit (3). Said unit (3) is provided with a processor module (3.2) which is operable to process data collected by at least a sensory module (3.1) in order to determine the location and magnitude of an impact produced by a user's strike on the bag's body (1). Thus, the apparatus disclosed in the present application provides enhanced tracking of training performance and increased engagement of the intelligence of the user as the training is undertaken.

### FIELD OF THE APPLICATION

The present application relates generally to physical training devices and systems. More specifically, this application relates to punching bags used for professional or recreational training of boxing or martial arts.

### PRIOR ART

Punching bags were originally used by boxers or martial arts practitioners to improve overall punching techniques. Recently, punching bags are being used by people who are not practitioners, but want to receive the strength and aerobic benefits achieved through performing the motion of punching. Furthermore, punching bags are now used as source of stress relief by many people, since martial arts training programs have proved to be an effective way to improve health and fitness. Many people see positive results from martial arts training, such as improved cardiovascular endurance, increased muscular strength and tone, as well as weight loss. It also helps users gain a sense of inner strength and emotional balance.

Martial arts training sessions are typically complemented with various devices. One of the most common devices used in martial arts training is the punching bag. The punching bag resembles an opponent and is designed to be repeatedly punched and kicked. Traditional punching bags and other training devices primarily lack the ability to provide performance tracking and feedback. As a result, multiple devices in the prior art have incorporated electronic components that enable them to capture and feedback user's performance data.

A problem with these known punching bag apparatuses is that the sensor configuration may be unreliable and not be suitable for or be able to accurately record any type of strike at a variety of locations on the punching bag and/or the sensors may give false readings.

Accordingly, there is a need for an improved punching bag which provides enhanced tracking of training performance, especially in what concerns to determining the location and magnitude of the user's strike in an accurate manner, regardless of where on the punching bag the strike is delivered, thereby increasing engagement of the intelligence of the trainee as the training is undertaken.

### SUMMARY OF THE APPLICATION

It is, therefore, an objective of the present application to describe a solution to overcome the deficiencies identified in the state of the art.

In order to achieve this objective, an electronic punching bag is proposed, which comprises an impact measurement unit including a sensory module adapted to detect the force of an impact produced by a user's strike on the bag, and a processor module comprising a machine learning module configured to analyse impact force data collected by the sensory module as a result of a user's strike, and to identify specific pattern responses associated with standard impact force data produced from user's strikes at specific locations on the bag. To this end, the punching surface of the bag is divided into quadrants, defining said specific locations in the bag, and the sensors of the sensory module are arranged along a longitudinal axis inside the bag. With this scheme, a machine learning model is trained so that, following a detection of an impact force, it is possible to automatically identify which quadrant or quadrants may have been hit by the user's strike.

In an advantageous configuration of the electronic punching bag object of the present application, the impact measurement unit further includes a video recording module, adapted to record said user's strike. The data collected by the sensory module is used to determine the magnitude of the impact force produced by the user's strike, whereas the combination of the data collected by the two modules, i.e., the sensory module and the video recording module, is used to determine, in a more efficient and accurate way, the location on the bag where the user's strike is delivered. In fact, since quadrants that are positioned at the same distance from a sensor may have very similar pattern responses, the processing of the user's strike video data, captured by the video recording module, is thus advantageous in allowing the selection of the correct quadrant and thus the correct location of the strike, in case of ambiguity. As a consequence, the magnitude and location of the impact force is determined regardless of the type of strike that is executed by the user and the part of the body used to contact the bag.

Finally, it is also an object of the present application a method for determining the location and magnitude of an impact force produced by a user's strike on an electronic punching bag.

### DESCRIPTION OF FIGURES

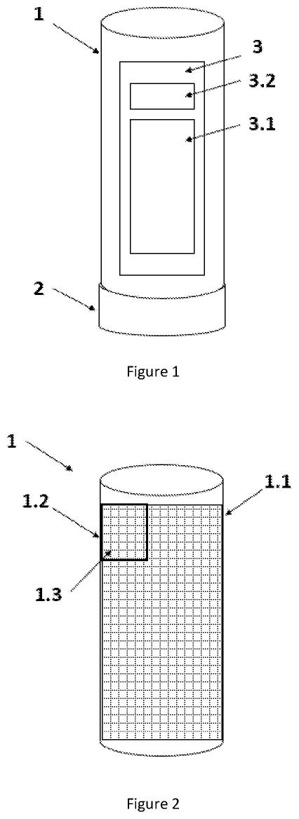

FIG. 1—representation of an embodiment of the electronic punching bag of the present application, wherein the reference signs represent:
1—punching bag;
2—anchoring unit;
3—impact measurement unit;
3.1—sensory module;
3.2—processor module.

FIG. 2—in the context of determining the location on the bag where a user's strike is delivered, it is illustrated an embodiment of the punching bag, where the bag's punching surface is divided into a plurality of levels, each level comprising a plurality of smaller quadrants; the reference signs represent:
1—punching bag;
1.1—bag's punching surface;
1.2—level;
1.3—quadrant.

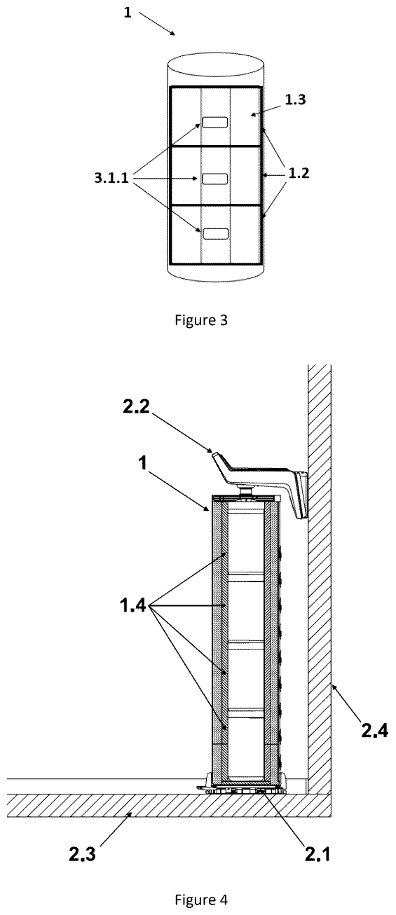

FIG. 3—representation of an embodiment of the electronic punching bag object of the present application, illustrating the position of the sensor submodules of the sensory module in relation to the level/quadrant subdivision of the bag's punching surface; the reference signs represent:
1—punching bag;
1.2—level;
1.3—quadrant;
3.1.1—sensor submodule.

FIG. 4—representation of an embodiment of the electronic punching bag object of the present application, where the anchoring unit comprises a base module and a supporting structure, being projected to provide support of the bag on a first and on a second surface, said surfaces being perpendicular to each other; Additionally, the bag's inner core is formed by a set of four bladders stacked on top of each other; the reference signs represent:
1—punching bag;
1.4—bladder;
2.1—base module;
2.2—supporting structure;
2.3—first supporting surface;
2.4—second supporting surface.

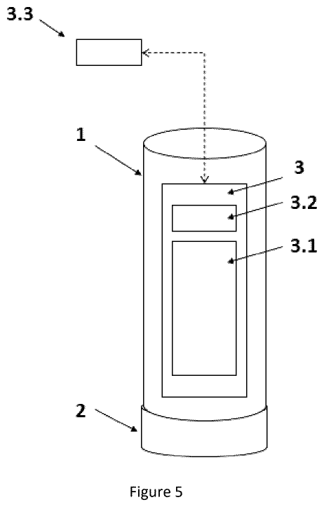

FIG. 5—illustration of an embodiment of the electronic punching bag of the present application, where the impact measurement unit further includes a video recording module, used to record the user's strike on the bag's punching surface; the reference signs represent:
1—punching bag;
2—anchoring unit;
3—impact measurement unit;
3.1—sensory module;
3.2—processor module;
3.3—video recording unit.

### DESCRIPTION OF THE APPLICATION

The present application relates to an electronic punching bag apparatus. In one embodiment, the electronic punching bag apparatus is comprised by a punching bag (1), an anchoring unit (2) and an impact measurement unit (3).

In the context of the present application, a punching bag (1) is to be understood as a resistant body designed to be repeatedly punched, having, typically an elongated body of a cylindrical shape.

The anchoring unit (2) is adapted to fix the apparatus to at least one surface, which may be any type of mechanism known in the state of the art that allows this purpose to be achieved.

The impact measurement unit (3) is comprised by a sensory module (3.1) and by a processor module (3.2).

The sensory module (3.1) comprises sensor means, installed within the bag and configured to detect an impact force produced by a user's strike on a bag's punching surface (1.1) and to generate a corresponding impact force data. In the context of the present application, an impact force is the force produced by a user's strike when it reaches the punching bag. Impact force data relates to a measure of force, result of the detection and processing stages carried out in the sensory module, and it may be expressed in terms of Intenational System base units (for example kg·m/s²), derivated units (for example in Newton) or in a proprietary metric system specially developed.

The processor module (3.2) comprises a machine learning module. Said machine learning module comprises a training dataset unit adapted to store a training dataset including at least impact force data generated by the sensory module (3.1) and associated class definition based on a subdivision of the bag's punching surface (1.1) into a plurality of levels (1.2), each comprising progressively smaller quadrants (1.3) down to a predefined size, each quadrant (1.3) corresponding to a unique location in said bag's punching surface (1.1). The size of each quadrant (1.3) can be defined as a function of the level of precision to be obtained in determining the location of the impact, that is, the level of accuracy increases with decreasing quadrant (1.3) size. Since the user's contact with the bag (1), following the execution of a strike, takes place along a certain area, depending, for example, on how bulky the boxing glove is, it can be mentioned that the size of a quadrant (1.3) may be define as an area of 25 cm² or 50 cm² if a greater precision is desired in obtaining the location of the impact. On the other hand, the size of a quadrant may be defined as an area of 400 cm² or 625 cm² if the required precision is smaller. However, the size of a quadrant (1.3) can be progressively reduced to a minimum value, through the evolution and knowledge acquisition of the machine learning module, which allows for greater precision in determining the location of an impact,.

The processor module (3.2) further comprises a computing unit configured to train a machine learning classifier to recognize quadrants (1.3) hit by a user's strike using the training dataset and using at least the impact force data generated from the user's strike as test input to the machine learning classifier to determine at least one quadrant (1.3) hit by the user's strike. Additionally, the processor module (3.2) also has processing means configured to determine the location in the bag of the user's strike based on the correspondent at least one quadrant location and to determine the magnitude of the user's strike based on the impact force data generated by the sensory module (3.1).

By means of the described computational and sensorial scheme, which involves machine learning mechanisms, it is possible in an accurate manner to determine the location and magnitude of the user's strike, regardless of where on the punching bag the strike is delivered.

In another embodiment of the electronic punching bag apparatus of the present application, the punching bag (1) has an elongated body and its punching surface (1.1) is divided into at least three horizontal levels (1.2), defining a top, central and lower sections of the punching bag. In this particular case, the sensory module (3.1) is comprised by a plurality of sensor elements, adapted to detect the impact force produced by the user's strike on the bag's punching surface (1.1), that are incorporated within the elongated body and positioned along at least one longitudinal axis.

More particularly, and in another embodiment, the sensor elements are grouped into at least three sensor submodules (3.1.1) positioned along one longitudinal axis and being equally spaced from each other. Each sensor submodule (3.1.1) is positioned in the top, central and lower horizontal sections (1.2) of the punching bag (1), respectively.

in this way, a uniform distribution of the sensors along the bag's punching surface (1.1) is ensured, which favours the collection of data and respective processing for the purpose of determining the location of the impact.

The sensor elements may be a combination of the following: at least one accelerometer, at least one gyroscope and at least one magnetometer. Preferably, the sensor elements may be a combination of the following: at least one 3-axis accelerometer, at least one 3-axis gyroscope, and at least one 3-axis magnetometer. Regarding the sensor submodules (3.1.1), each may be comprised by at least one 3-axis accelerometer, at least one 3-axis gyroscope and at least one 3-axis magnetometer.

In another embodiment of the electronic punching bag apparatus described in the present application, the anchoring unit (2) comprises a base module (2.1) and a supporting structure (2.2).

The base module (2.1) is connected to a bottom of the bag's body, and provides support for the bag on a first surface (2.3). In its turn, the supporting structure (2.2) is adapted to fix the bag to a second surface (2.4), perpendicular to the first surface (2.3). Preferentially, the supporting structure (2.3) is fixed on an upper part of the bag's body.

The punching bag's body has an elongated shape and comprises an internal core part, constituted by a bladder structure comprised by at least one bladder (1.4), said bladder (1.4) being a container for liquid storage.

Fixing the bag (1) on two perpendicular surfaces, together with the bag's internal bladder structure, allow to determine more reliable impact force data, since the bag's reaction movements following a user's strike are limited to a certain range, contributing to noise reduction in sensor readings, and also allowing that, through data processing, the remaining noise can be more effectively neglected.

In one embodiment, the bladder structure comprises an array of 4 bladders (1.4) being disposed lengthwise in one longitudinal axis. The bladders (1.4) of the array have a shape adapted to be staked one on top of the other, and optionally, the volume of each bladder (1.4) is 20 litres, the liquid being water.

In another embodiment of the electronic punching bag apparatus of the present application, the impact measurement unit (3) further comprises a video recording module (3.3), programmed to record the user's training session, particularly, the user's strike on the bag's punching surface (1.1) and to generate corresponding impact video data. In connection with this embodiment, the processing means of the processor module (3.2) are further configured to determine the location of the user's strike based on the correspondent quadrant location and on the impact video data.

More particularly, the data collected by the sensory module (3.1) is used to determine the magnitude of the impact force produced by the user's strike, whereas the combination of the data collected by the two modules, i.e., the sensory module (3.1) and the video recording module (3.3), is used to determine, in a more efficient way, the location on the bag where the user's strike is delivered. In fact, since quadrants that are positioned at the same distance from a sensor may have very similar pattern responses, the processing of the user's strike video data, captured by the video recording module (3.3), is thus advantageous in allowing the selection of the right quadrant and thus the correct location of the strike, in case of ambiguity. As a consequence, the magnitude and location of the impact force is determined regardless of the type of strike that is executed by the user and the part of the body used to contact the bag.

In another embodiment, the video recording module (3.3) comprises processing means configured to process the user's strike recorded video data using computer vision algorithms in order to generate a correspondent impact video data. In the context of the present application, computer vision algorithms are algorithms adapted to analyse certain criteria in the user's strike recorded video data and apply interpretations to predictive or decision making tasks, more particularly to retrieve from the processed video data information regarding at least a longitudinal section (1.2) of the punching bag (1) hit by the user's strike, said longitudinal section (1.2) referring to lateral sections, i.e., left or right section, or a central section. Deep learning and optical flow techniques are examples of computer vision algorithms that can be implemented to achieve the identified purpose.

In another embodiment, the processing means of the video recording module (3.3) are further configured to process the user's strike recorded video data using a skeleton analysis algorithm in order to generate a correspondent impact video data. Said skeleton analysis algorithm being adapted to retrieve from the processed video data information regarding a type a user's strike. Additionally, the processor module (3.2) of the impact measurement unit (3) is further configured to determine the direction of the impact force produced by the user's strike based on the impact location and impact video data.

It is also an object of the present application, a method for determining the location and magnitude of an impact force produced by a user's strike on an electronic punching bag.

The method comprises the following steps:
i. subdividing, by a control mechanism, a punching surface (1.1) of the punching bag (1) into a plurality of levels (1.2) each comprising progressively smaller quadrants (1.3) down to a predefined size; each quadrant (1.3) corresponding to a unique location in said bag's punching surface (1.1);
ii. receiving a training dataset comprising at least impact force data and an associated class definition based on quadrants (1.3) resulting from the subdivision of the bag's punching surface (1.1);
iii. training one or more machine learning classifiers to construct a model to classify the at least impact force data into one or more classes based on the training dataset;
iv. generating a user's impact force data by a sensing mechanism installed within the bag (1), upon detection of an impact force produced by a user's strike on the bag's punching surface (1.1);
v. receiving at least the user's impact force data as test input to the at least one machine learning classifier to classify said user's impact force data using the constructed model into one or more classes; each class representing a quadrant (1.3);
vi. associating, by the control mechanism, the classified user's impact force to at least one quadrant (1.3) and determining the location of the user's strike based on the at least one correspondent quadrant location;
vii. determining, by the control mechanism, the magnitude of the user's strike based on the impact force data generated by the sensing mechanism.

In one embodiment of the method, the detection of an impact force comprises the following steps:
measuring an impact force signal resulting from a user's action on the bag (1);
implementing a peak detection algorithm, in order to identify a peak value on said impact force signal;
comparing the peak value with a predefined threshold value;
detecting an impact force produced by a user's strike if the peak value is above the predefined threshold value.

In another embodiment of the method, it further comprises the steps of:
recording a video data of a user's workout session, by a video recording mechanism; said video data comprising at least a plurality of video frames capturing a user's strike on the bag's punching surface;
processing, by the video recording mechanism, the plurality of video frames related to the user's strike, in order to generate impact video data;
determining, by the control mechanism, the location of the user's strike based on the correspondent at least one quadrant location and impact video data.

Additionally, the generation of the impact video data comprises the following steps:
processing the plurality of video frames corresponding to the user's strike using a computer vision algorithm;
extracting information from the processed recorded video data, regarding a bag's longitudinal section (1.2) hit by the user's strike; said longitudinal section referring to lateral sections, i.e., left or right section, or a central section; generating a corresponding impact video signal including at least information about the longitudinal section hit by the user's strike.

In another embodiment of the method, the location of the user's strike on the bag's punching surface (1.1) comprises:
processing, by the control mechanism, the information related to the at least one quadrant location and to the impact video data;
determining the interception between the location of at least one quadrant (1.3) hit by the user's strike and the longitudinal section (1.2) of the bag hit by said user's strike.

In another embodiment of the method, the step of determining the magnitude of the user's strike comprises processing the impact force data according to a universal measuring metric.

### EXAMPLE OF REALIZATION

The present application relates to an electronic punching bag.

The main objective is that the developed punching bag (1) is able to fill all the gaps of the apparatuses of the state of the art, being able not only to detect all kinds of impacts, be they punches, elbows or kicks, but also the location of the impacts and the strength of these, in the SI Newton unit.

In order to achieve the required efficiency, the punching surface (1.1) is divided in 9 distinct quadrants (1.3), defining each quadrant (1.3) an impact location. This scheme is in itself already a differentiating aspect compared to all existing apparatuses.

Besides that, in a preferred embodiment, the electronic punching bag is based on an array of IMU (inertial measurement unit) sensors consisting of 3 acceleration axes and 3 gyroscope axes each to detect impacts and force in several possible quadrants (1.3). The bag (1) may also include all the electronics that complement it, forming the impact measurement unit (sensory module, video recording module and processor module) connected to a System on Chip—SoC.

As an example, a low-energy SoC may be used having an architecture which allows to run Digital Signal Processing algorithms and real-time inference models. Additionally, it may also feature high energy efficiency and integrates a 2.4 GHz transceiver to implement Bluetooth low energy-BLE.

Regarding the sensory module, the IMU sensors are distributed over three vertical areas (1.2) of the bag (1) allowing not only to detect the impacts, but also by comparing the vector module of the 3 acceleration axes of each sensor, to understand in which zone (above, in the middle or below) the impact was given so that then, through algorithms of analysis of the directivity of the impact and with the help of the video recording module (3.3) is possible to understand if the impact was in the left, centre or right section of the bag and consequently manage to limit the impact zone to one of the nine possible quadrants (1.3).

These sensors may communicate with soc through a synchronous series communication protocol, such as I2C.

Additionally, the sensory module (3.1) may also include processing skills adapted to implement a set of digital processing algorithms to reduce noise and allow parametrization of sampling frequency and sensitivity, and also to internally perform calibration stages necessary to increase measurement accuracy, as well as determine a data set from accelerometer a gyroscope data such as relative orientation and linear acceleration.

In order to be able to observe the data from the various IMU sensors and the data resulting from the implemented digital signal processing algorithms, as well as understand how the impact detection algorithms are behaving, a set of processing scripts may be implemented in order to connect, for example, the serial port of a processing device to the SoC and allow to view the data in real time.

Alternatively, this data may be transmitted via wireless network communication protocol to an external processing device, such as a smartphone.

1. An electronic punching bag apparatus comprising:
a punching bag (1);
an anchoring unit (2), adapted to fix the apparatus to at least one surface;
an impact measurement unit (3) comprising:
a sensory module (3.1) comprising sensor means configured to detect an impact force produced by a user's strike on a bag's punching surface (1.1) and to generate a corresponding impact force data;
a processor module (3.2) comprising a machine learning module; said machine learning module comprising:
a training dataset unit adapted to store a training dataset including at least impact force data generated by the sensory module (3.1) and associated class definition based on a subdivision of the bag's punching surface (1.1) into a plurality of levels (1.2) each comprising progressively smaller quadrants (1.3) down to a predefined size; each quadrant (1.3) corresponding to a unique location in said bag's punching surface (1.1);
the processor module further (3.2) comprising:
a computing unit configured to train a machine learning classifier to recognize quadrants (1.3) hit by a user's strike using the training dataset and using at least the impact force data generated from the user's strike as test input to the machine learning classifier to determine at least one quadrant (1.3) hit by the user's strike;
processing means configured to determine the location in the bag of the user's strike based on the correspondent at least one quadrant location and to determine the magnitude of the user's strike based on the impact force data generated by the sensory module (3.1).

2. The apparatus according to claim 1, wherein the punching bag (1) has an elongated body and the bag's punching surface (1.1) being divided into at least three horizontal levels (1.2), defining a top, central and lower sections of the punching bag; and wherein,
the sensory module (3.1) comprises a plurality of sensor elements adapted to detect the impact force produced by the user's strike on the bag's punching surface (1.1); said sensor elements being incorporated within the elongated body and positioned along at least one longitudinal axis.

3. The apparatus according to claim 2, wherein the sensor elements are grouped into at least three sensor submodules (3.1.1) positioned along one longitudinal axis and being equally spaced from each other; each sensor submodule (3.1.1) being position in the top, central and lower horizontal sections (1.2) of the punching bag (1), respectively.

4. The apparatus according to claim 3, wherein the sensor elements are a combination of the following: at least one accelerometer, at least one gyroscope and at least one magnetometer; preferably, the sensor elements are a combination of the following: at least one 3-axis accelerometer, at least one 3-axis gyroscope, and at least one 3-axis magnetometer; and wherein, each sensor submodule (3.1.1) comprising at least one 3-axis accelerometer, at least one 3-axis gyroscope and at least one 3-axis magnetometer.

5. The apparatus according to claim 1, wherein the anchoring unit (2) comprises:
a base module (2.1) being connected to a bottom of the bag's body; the base module (2.1) providing support for the bag on a first surface (2.3); and
a supporting structure (2.2) adapted to fix the bag to a second surface (2.4);
said second surface (2.4) being perpendicular to the first surface (2.3);
and wherein the punching bag (1) has a body which comprises:
an internal core part constituted by a bladder structure comprised by at least one bladder (1.4); said bladder (1.4) being a container for liquid storage.

6. The apparatus according to claim 5, wherein the bladder structure comprises an array of 4 bladders (1.4) being disposed lengthwise in one longitudinal axis; the bladders (1.4) of the array having a shape adapted to be staked one on top of the other; optionally, the volume of each bladder (1.4) is 20 litres and the liquid is water.

7. The apparatus according to claim 1, wherein the impact measurement unit (3) further comprises:
a video recording module (3.3) programmed to record the user's strike on the bag's punching surface (1.1) and to generate corresponding impact video data; and wherein,
the processing means of the processor module (3.2) being further configured to determine the location of the user's strike based on the correspondent quadrant location and on the impact video data.

8. The apparatus according to claim 7, wherein the video recording module (3.3) of the impact measurement unit (3) comprises processing means configured to process the user's strike recorded video data using computer vision algorithms in order to generate a correspondent impact video data; said computer vision algorithms being adapted to retrieve from the processed video data information regarding at least a longitudinal section (1.2) of the punching bag (1) hit by the user's strike; said longitudinal section (1.2) referring to lateral sections, i.e., left or right section, or a central section.

9. The apparatus according to claim 8, wherein the processing means of the video recording module (3.3) are further configured to process the user's strike recorded video data using a skeleton analysis algorithm in order to generate a correspondent impact video data; said skeleton analysis algorithm being adapted to retrieve from the processed video data information regarding a type a user's strike; and wherein,
the processor module (3.2) of the impact measurement unit (3) is further configured to determine the direction of the impact force produced by the user's strike based on the impact location and impact video data.

10. A method for determining the location and magnitude of an impact force produced by a user's strike on an electronic punching bag; the method comprising the following steps:
i. subdividing, by a control mechanism, a punching surface (1.1) of the punching bag (1) into a plurality of levels (1.2) each comprising progressively smaller quadrants (1.3) down to a predefined size; each quadrant (1.3) corresponding to a unique location in said bag's punching surface (1.1);
ii. receiving a training dataset comprising at least impact force data and an associated class definition based on quadrants (1.3) resulting from the subdivision of the bag's punching surface (1.1);
iii. training one or more machine learning classifiers to construct a model to classify the at least impact force data into one or more classes based on the training dataset;
iv. generating a user's impact force data by a sensing mechanism installed within the bag (1), upon detection of an impact force produced by a user's strike on the bag's punching surface (1.1);
v. receiving at least the user's impact force data as test input to the at least one machine learning classifier to classify said user's impact force data using the constructed model into one or more classes; each class representing a quadrant (1.3);
vi. associating, by the control mechanism, the classified user's impact force to at least one quadrant (1.3) and determining the location of the user's strike based on the at least one correspondent quadrant location;
vii. determining, by the control mechanism, the magnitude of the user's strike based on the impact force data generated by the sensing mechanism.

11. Method according to claim 10, wherein the detection of an impact force comprises:
measuring an impact force signal resulting from a user's action on the bag (1);
implementing a peak detection algorithm, in order to identify a peak value on said impact force signal;
comparing the peak value with a predefined threshold value;
detecting an impact force produced by a user's strike if the peak value is above the predefined threshold value.

12. Method according to claim 9, further comprising the steps of:
recording a video data of a user's workout session, by a video recording mechanism; said video data comprising at least a plurality of video frames capturing a user's strike on the bag's punching surface;
processing, by the video recording mechanism, the plurality of video frames related to the user's strike, in order to generate impact video data;
determining, by the control mechanism, the location of the user's strike based on the correspondent at least one quadrant location and impact video data.

13. Method according to claim 12, wherein the generation of the impact video data comprises the following steps:
processing the plurality of video frames corresponding to the user's strike using a computer vision algorithm;
extracting information from the processed recorded video data, regarding a bag's longitudinal section (1.2) hit by the user's strike; said longitudinal section referring to lateral sections, i.e., left or right section, or a central section;
generating a corresponding impact video signal including at least information about the longitudinal section hit by the user's strike.

14. Method according to claim 12, wherein the location of the user's strike on the bag's punching surface (1.1) comprises:
processing, by the control mechanism, the information related to the at least one quadrant location and to the impact video data;
determining the interception between the location of at least one quadrant (1.3) hit by the user's strike and the longitudinal section (1.2) of the bag hit by said user's strike.

15. Method according to claim 9. wherein the step of determining the magnitude of the user's strike comprises processing the impact force data according to a universal measuring metric.
